(19) United States
(12) Patent Application Publication
(10) Pub. No.: US 2008/0118069 A1
(43) Pub. Date: May 22, 2008

(54) MOBILE COMMUNICATION SYSTEM, AND KEY SETTING METHOD

(75) Inventor: SHU-MIN YANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/616,904

(22) Filed: Dec. 28, 2006

(30) Foreign Application Priority Data
Nov. 17, 2006 (TW) 95142691

(51) Int. Cl. H04L 9/08

(52) U.S. Cl. 380/279

(57) ABSTRACT

A mobile communication system (10) includes a network access device (180), a mobile communication device (100), and a key management server (140). The network access device periodically broadcasts a beacon frame including an address of the network access device. The mobile communication device receives the beacon frame, retrieves the address of the network access device, and sends the address via a short message. The key management server receives the address, retrieves an identifiable name of the network access device according to the address, sends a key request to the network access device corresponding to the identifiable name to retrieve a key, and sends the key to the mobile communication device via another short message.

### BACKGROUND OF THE INVENTION

1. Field of the Invention

The invention relates to mobile communication systems, and particularly to a mobile communication system, and key setting method.

2. Description of related art

Electronic communication networks have become more and more popular due to developments in communication technology. Some public places, such as sports arenas and shopping centers, are equipped with networks for users of mobile terminals. If a user of a mobile terminal, such as a notebook computer, wants to connect to a network wirelessly, the mobile terminal must first set a key with an access point (AP) to authenticate itself to the AP for connecting to the network.

conventionally, the user of the mobile terminal presses a hard button or a soft button of the AP to disable a security function of the AP, and then the mobile terminal connects to the AP to set a key therebetween. The secure socket layer protocol (SSL) is used for encoding and/or decoding communication data in order to make sure of the security of the key. Thus, the mobile terminal must be equipped with the SSL protocol and digital certificate, and generation and transmission of the digital certificate brings heavy loading to the mobile terminal.

### SUMMARY OF THE INVENTION

In one aspect of the invention, a mobile communication system includes a network access device, a mobile communication device, and a key management server. The network access device is used for periodically broadcasting a beacon frame including an address of the network access device. The mobile communication device is used for receiving the beacon frame, retrieving the address of the network access device, and sending the address of the network access device via a short message. The key management server is used for receiving the address of the network access device, retrieving an identifiable name of the network access device according to the address of the network access device, sending a key request to the network access device corresponding to the identifiable name to retrieve a key, and sending the key to the mobile communication device via another short message.

In another aspect of the invention, a key setting method for use in a mobile communication system is provided. The key setting method includes steps of: retrieving an address of a network access device, and sending the address via a short message by a mobile communication device; receiving the address of the network access device, retrieving an identifiable name of the network access device according to the address of the network access device, and sending a key request to the network access device to retrieve a key; and receiving the key, and sending the key to the mobile communication device via another short message.

In a further aspect of the invention, a key setting method for use in a network access device is provided. The key setting method includes broadcasting a beacon frame including an address of the network access device to make a mobile communication device retrieve the address of the network access device and send the address to a key management server via a short message; receiving a key request sent by the key management server; generating a key according to the key request; and sending the key to the key management server to send to the mobile communication device via another short message.

In another further aspect of the invention, a key setting method for use in a mobile communication device is provided. The key setting method includes receiving a beacon frame sent by a network access device, and retrieving an address of the network access device by a mobile communication module; retrieving the address from the mobile communication module, and sending the address via a short message to a key management server to make the key management server request a key from the network access device; and receiving the key sent via another short message, and sending the key to the mobile communication module.

Other advantages and novel features will become more apparent from the following detailed description when taken in conjunction with the accompanying drawings.

### BRIEF DESCRIPTION OF THE DRAWINGS

FIG. 1 is a schematic diagram of a mobile communication system of an exemplary embodiment of the invention.

FIG. 2 is a schematic diagram of a mobile communication device of another exemplary embodiment of the invention.

FIG. 3 is a flowchart of a key setting method of a further exemplary embodiment of the invention.

FIG. 4 is a flowchart of a key setting method of another further exemplary embodiment of the invention.

FIG. 5 is a flowchart of a key setting method of a still further exemplary embodiment of the invention.

### DETAILED DESCRIPTION OF THE INVENTION

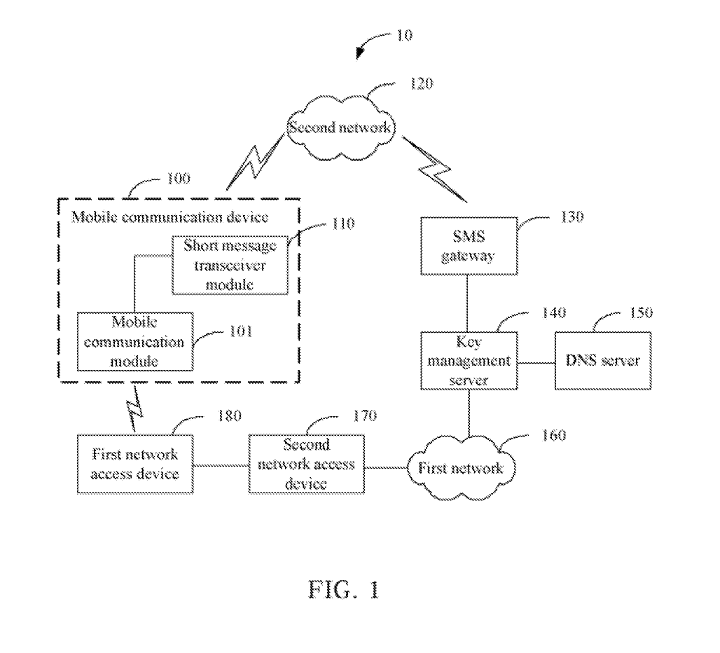

FIG. 1 is a schematic diagram of a mobile communication system 10 of an exemplary embodiment of the invention. In the exemplary embodiment, the mobile communication system 10 is used for setting a key between a mobile communication device 100 and a first network access device 180, and includes the mobile communication device 100, a short message service (SMS) gateway 130, a key management server 140, and the first network access device 180.

The first network access device 180 periodically broadcasts a beacon frame, and the beacon frame includes an address of the first network access device 180. In the exemplary embodiment, the first network access device 180 may be an access point, and broadcasts a beacon fame every 100 million second (ms). The beacon frame includes a media access control (MAC) address of the first network access device 180.

The mobile communication device 100 receives the beacon frame, retrieves the address of the first network access device 180, and sends the address of the first network access device 180 via a short message. In the exemplary embodiment, the mobile communication device 100 includes a mobile communication module 101 and a short message transceiver module 110. The mobile communication module 101 receives the beacon frame, and retrieves the address of the first network access device 180 from the received beacon frame. The short message transceiver module 110 retrieves the address of the first network access device 180 from the mobile communication module 101, and sends the address to the SMS gateway 130 via the short message.

In the exemplary embodiment, the mobile communication module 101 may be a portable computer, such as a laptop computer or a personal digital assistant, and the short message transceiver module 110 may be a mobile phone. The mobile communication module 101 connects to the short message transceiver module 110 via a signal transmission line, and communicates with the short message transceiver module 110 via attention (AT) commands. In alternative embodiments, the short message transceiver module 110 may be a software module embedded in the mobile communication module 101 for receiving and transmitting short messages. The mobile communication module 101 sends the address of the first network access device 180 to the short message transceiver module 110 via AT commands. In alternative embodiments, a user of the mobile communication module 101 and the short message transceiver module 180 can input the address of the first network access device 180 to the short message transceiver module 180.

In an alternative embodiment, the mobile communication device 100 may be a dual mode phone, the mobile communication module 101 may be a WIFI module thereof, and the short message transceiver module 110 may be a global system for mobile communication (GSM) module or a code division multiple access (CDMA) module.

The SMS gateway 130 is used for receiving the short message sent by the mobile communication device 100, retrieves the address of the first network access device 180 from the short message, and sends the address to the key management server 140.

The key management server 140 is used for receiving the address of the first network access device 180 sent by the SMS gateway 130, retrieving an identifiable name of the first network access device 180 according to the address, sending a key request to the first network access device 180 to retrieve a key according to the retrieved identifiable name, and sending the key to SMS gateway 130. Then the SMS gateway 130 sends the key to the short message transceiver module 110 via another short message, and the short message transceiver module 110 sends the key to the mobile communication module 101. In the exemplary embodiment, the identifiable name of the first network access device 180 may be an Internet protocol (IP) address of the first network access device 180.

The mobile communication system 10 further includes a first network 160 for connecting the key management server 140 to the first network access device 180. In the exemplary embodiment, the first network 160 may be an Internet network. The mobile communication system 10 further includes a second network access device 170 for connecting the first network access device 180 to the first network 160, and the second network access device 170 may be a modem.

The mobile communication system 10 further includes a second network 120 for connecting the short message transceiver module 110 to the SMS gateway 130. In the exemplary embodiment, the second network 120 may be a GSM network. In alternative embodiments, the second network 120 may be a CDMA network.

The mobile communication system 10 further includes a domain name system (DNS) server 150. The DNS server 150 is connected to the key management server 140, and is used for saving addresses and corresponding identifiable names of the first network access device 180. The key management server 140 searches the DNS server 150 according to the address of the network access device 180 to retrieve the corresponding identifiable name of the network access device 180. In alternative embodiments, the SMS gateway 130, the key management server 140, and the DNS server 150 can be integrated into one device.

In an alternative embodiment, the short message sent by the short message transceiver module 110 further includes an address of the mobile communication module 101. In the exemplary embodiment, the address of the mobile communication module 101 is a MAC address thereof. The SMS gateway 130 further sends the address of the mobile communication module 101 to the key management server 140, and the key management server 140 validates the mobile communication module 101 according to the address of the mobile communication module 101.

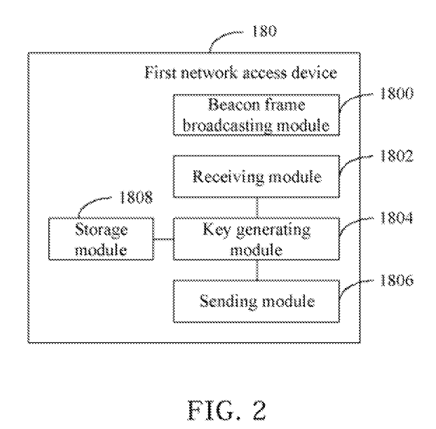

FIG. 2 is a schematic diagram of the first network access device 180. The first network access device 180 includes a beacon frame broadcasting module 1800, a receiving module 1802, a key generating module 1804, and a sending module 1806. The beacon frame broadcasting module 1800 periodically broadcasts a beacon frame, and the beacon frame includes the address of the first network access device 180. Thus the mobile communication device 100 can retrieve the address of the first network access device 180, and send the address to the key management server 140 via the SMS gateway 130.

The receiving module 1802 is used for receiving the key request sent by the key management server 140. The key generation module 1804 is used for generating a key according to the key request. In the exemplary embodiment, the key generation module 1804 generates the key dynamically. The sending module 1806 is used for sending the key to the key management server 140 to send to the mobile communication device 180. In the exemplary embodiment, the key request and the key are sent via Internet packets.

In alternative embodiments, the first network access device 180 further includes a storage module 1808 connected to the key generation module 1804 for saving preset keys. In the embodiment, the key generation module 1804 selects a key from the storage module 1808 according to the key request.

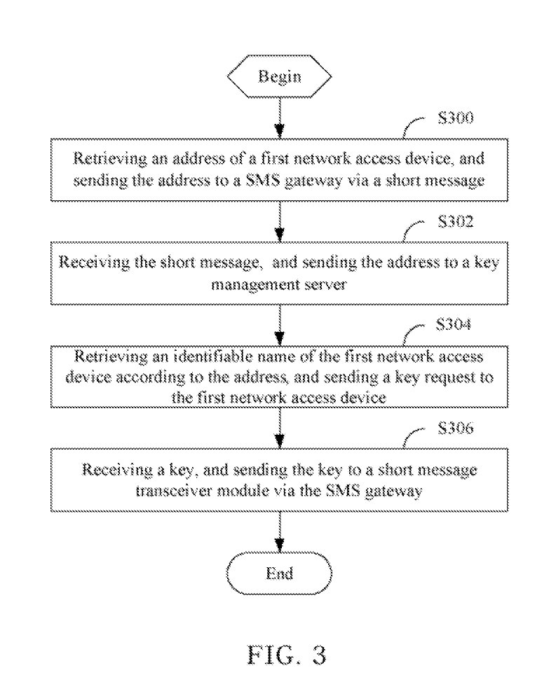

FIG. 3 is a flowchart of a key setting method of an exemplary embodiment of the invention. In the exemplary embodiment, the key setting method is used for setting keys between the first network access device 180 and the mobile communication module 101. The first network access device 180 periodically broadcasts a beacon frame including an address thereof.

In step S300, the mobile communication device 100 retrieves the address of the first network access device 180, and sends the address to the SMS gateway 130 via a short message.

In step S302, the SMS gateway 130 receives the short message, retrieves the address of the first network access device 180, and sends the address to the key management server 140.

In step S304, the key management server 140 receives the address of the first network access device 180, retrieves an identifiable name of the first network access device 180 according to the address, and sends a key request to the first network access device 180 corresponding to the identifiable name. The first network access device 180 receives the key request, generates and sends back a key.

In step S306, the key management server 140 receives the key, and sends the key to the mobile communication device 100 via the SMS gateway 130 via another short message.

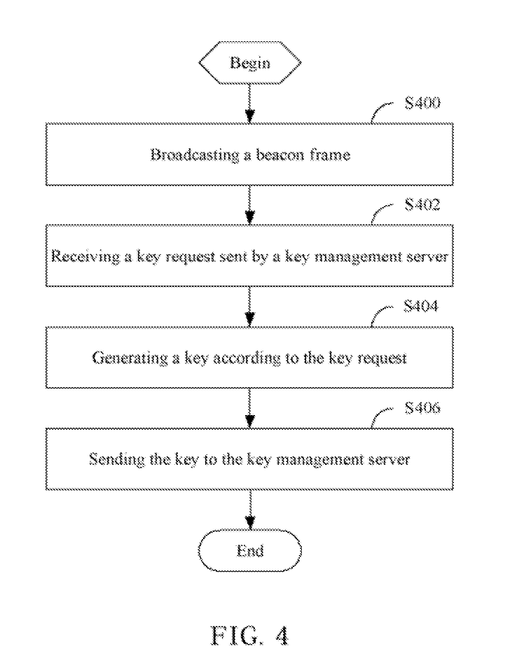

FIG. 4 is a flowchart of a key setting method of the first network access device 180. In step S400, the beacon frame broadcasting module 1800 of the first network access device 180 broadcasts a beacon frame including the address of the first network access device 180, thereby the mobile communication device 100 can retrieve the address, and send the address to the key management server 140. The key management server 140 retrieves an identifiable name of the first network access device 180 according to the address, and sends a key request to the first network access device 180 corresponding to the identifiable name.

In step S402, the receiving module 1802 receives the key request sent by the key management server 140.

In step S404, the key generation module 1804 generates a key according to the key request.

In step S406, the sending module 1806 sends the key to the key management server 140 to send to the mobile communication device 100.

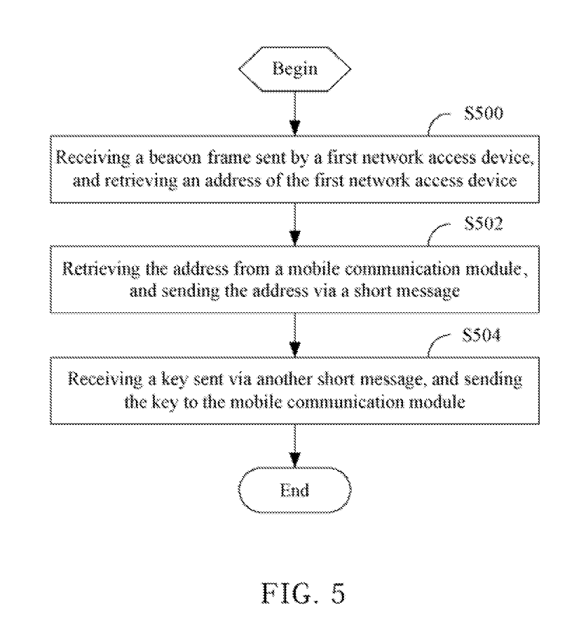

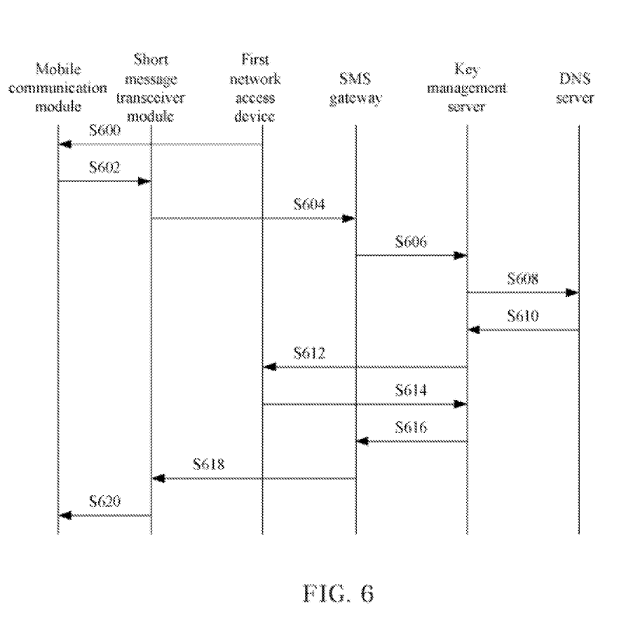

FIG. 5 is a flowchart of a key setting method of the mobile communication device 100. In step S500, the mobile communication module 101 of the mobile communication device 100 receives the beacon frame sent by the first network access device 180, and retrieves an address of the first network access device 180.

In step S502, the short message transceiver module 110 retrieves the address of the first network access device 180 from the mobile communication module 101, and sends the address via a short message to the SMS gateway 130 to send to the key management server 140. The key management server 140 sends a key request to the first network access device 180 to retrieve a key. In the exemplary embodiment, the mobile communication module 101 sends the address to the short message transceiver module 110 via AT commands.

In step S504, the short message transceiver module 110 receives the key sent via another short message, and sends the key to the mobile communication module 101. In the exemplary embodiment, the short message transceiver module 110 sends the key to the mobile communication module 101 via AT commands.

FIG. 6 is a detailed flowchart of a key setting method. In step S600, the first network access device 180 broadcasts a beacon frame including an address of the first network access device 180. In the exemplary embodiment, the address may be a MAC address of the first network access device 180.

In step S602, the mobile communication module 101 receives the beacon frame, retrieves the address of the first network access device 180, and sends the address to the short message transceiver module 110. In the exemplary embodiment, the mobile communication module 101 sends the address to the short message transceiver module 110 via AT commands. In alternative embodiments, the user of the mobile communication module 101 input the address of the first network access device 180 to the short message transceiver module 100.

In step S604, the short message transceiver module 110 receives the address of the first network access device 180, and sends the address to the SMS gateway 130 via a short message.

In step S606, the SMS gateway 130 receives the address of the first network access device 180, and sends the address to the key management server 140. In the exemplary embodiment, the SMS gateway 130 sends the address of the first network access device 180 to the key management server 140 via AT commands.

In step S608, the key management server 140 sends the address of the first network access device 180 to the DNS server 150 to search for an identifiable name of the first network access device 180. In the exemplary embodiment, the identifiable name of the first network access device 180 is an IP address of the first network access device 180.

In step S610, the DNS server 150 sends the identifiable name of the first network access device 180 to the key management server 140.

In step S612, the key management server 140 sends a key request to the first network access device 180 corresponding to the identifiable name.

In step S614, the first network access device 180 receives the key request, generates a key according to the key request, and sends the key to the key management server 140. In the exemplary embodiment, the communications of steps S608, S610, S612, and S614 are done via Internet packets.

In step S616, the key management server 140 receives the key, and sends the key to the SMS gateway 130. In the exemplary embodiment, the key management server 140 sends the key to the SMS gateway 130 via AT commands.

In step S618, the SMS gateway 130 sends the key to the short message transceiver module 110 via another short message.

In step S620, the short message transceiver module 110 sends the key to the mobile communication module 101. In the exemplary embodiment, the short message transceiver module 110 sends the key to the mobile communication module 101 via AT commands. Thus, the key between the mobile communication module 101 and the first network access device 180 is successfully set.

The key between the mobile communication module 101 and the first network access device 180 can be set by the short message transceiver module 110 via short messages without additional protocols and programs, thereby decreasing loads of the mobile communication module 101.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A mobile communication system, comprising:
a network access device, for periodically broadcasting a beacon frame comprising an address of the network access device;
a mobile communication device, for receiving the beacon frame, retrieving the address of the network access device, and sending the address of the network access device via a short message; and
a key management server, for receiving the address of the network access device, retrieving an identifiable name of the network access device according to the address of the network access device, sending a key request to the network access device corresponding to the identifiable name to retrieve a key, and sending the key to the mobile communication device via another short message.

2. The mobile communication system of claim 1, wherein the address of the network access device is a media access control (MAC) address thereof, and the identifiable name of the network access device is an Internet protocol address thereof.

3. The mobile communication system of claim 1, further comprising a short message service (SMS) gateway, for receiving the short message sent by the mobile communication device, retrieving the address of the network access device from the short message, sending the address of the network access device to the key management server, receiving the key sent by the key management server, and sending the key to the mobile communication device via the another short message.

4. The mobile communication system of claim 3, wherein the mobile communication device comprises:
a mobile communication module, for receiving the beacon frame and retrieving the address of the network access device; and
a short message transceiver module, for retrieving the address of the network access device from the mobile communication module and sending the address to the SMS gateway via the short message.

5. The mobile communication system of claim 4, wherein the mobile communication module is a portable computer, the short message transceiver module is a mobile phone connected to the mobile communication module via a signal transmission line, and the mobile communication module communicates with the short message transceiver module via attention (AT) commands.

6. The mobile communication system of claim 4, wherein the mobile communication device is a dual mode phone, the mobile communication module is a WIFI module thereof, and the short message transceiver module is a global system for mobile communication (GSM) module.

7. The mobile communication system of claim 1, further comprising a domain name system (DNS) server connected to the key management server, for saving addresses and corresponding identifiable names of the network access devices, and the key management server searches the DNS server to retrieve the identifiable name of the network access device according to the address of the network access device.

8. The mobile communication system of claim 1, wherein the network access device is an access point.

9. A key setting method, for use in a mobile communication system, comprising:
retrieving an address of a network access device, and sending the address via a short message by a mobile communication device;
receiving the address of the network access device, retrieving an identifiable name of the network access device according to the address of the network access device, and sending a key request to the network access device to retrieve a key by a key management server; and
receiving the key, and sending the key to the mobile communication device via another short message.

10. The key setting method of claim 9, wherein the step of retrieving an address of a network access device, and sending the address via a short message by a mobile communication device comprises steps of:
receiving a beacon frame broadcast by the network access device, and retrieving the address of the network access device by a mobile communication module;
sending the address to a short message transceiver module; and
sending the address to a short message service (SMS) gateway via the short message.

11. The key setting method of claim 10, wherein the step of sending the address to a short message transceiver module comprises steps of:
sending the address of the network access device to the short message transceiver module via attention (AT) commands.

12. The key setting method of claim 9, wherein the step of retrieving an identifiable name of the network access device according to the address of the network access device comprises steps of:
searching a domain name system (DNS) server according to the address of the network access device to retrieve the identifiable name of the network access device.

13. The key setting method of claim 9, further comprising steps of:
receiving the short message by a short message service (SMS) gateway;
retrieving the address of the network access device from the short message; and
sending the address to the key management server.

14. The key setting method of claim 13, wherein the step of receiving the key, and sending the key to the mobile communication device via another short message comprises steps of:
receiving the key, and sending the key to the SMS gateway;
sending the key to a short message transceiver module via the another short message; and
sending the key to a mobile communication module via AT commands.

15. A key setting method, for use in a network access device, comprising:
broadcasting a beacon frame comprising an address of the network access device to make a mobile communication device retrieve the address of the network access device and send the address to a key management server via a short message;
receiving a key request sent by the key management server;
generating a key according to the key request; and
sending the key to the key management server to send to the mobile communication device via another short message.

16. The key setting method of claim 15, wherein the step of generating a key according to the key request comprises steps of:
dynamically generating the key according to the key request.

17. The key setting method of claim 15, wherein the step of generating a key according to the key request comprises steps of:
selecting the key from a storage module according to the key request.

18. A key setting method, for use in a mobile communication device, comprising:
receiving a beacon frame sent by a network access device, and retrieving an address of the network access device by a mobile communication module;
retrieving the address from the mobile communication module, and sending the address via a short message to a key management server to make the key management server request a key from the network access device; and
receiving the key sent via another short message, and sending the key to the mobile communication module.

19. The key setting method of claim 18, further comprising steps of:
sending the address of the network access device to a short message transceiver module via attention commands.
